(19) United States
(12) Patent Application Publication
(10) Pub. No.: US 2013/0173054 A1
(43) Pub. Date: Jul. 4, 2013

(54) METHOD OF CONTROLLING BALANCE OF WALKING ROBOT

(71) Applicants: Jung Ho Seo, Hwaseong (KR); Woo Sung Yang, Hwaseong (KR)

(72) Inventors: Jung Ho Seo, Hwaseong (KR); Woo Sung Yang, Hwaseong (KR)

(73) Assignee: HYUNDAI MOTOR COMPANY, Seoul (KR)

(21) Appl. No.: 13/540,828

(22) Filed: Jul. 3, 2012

(30) Foreign Application Priority Data
Jan. 2, 2012 (KR) 10-2012-0000026

(51) Int. Cl. G06F 19/00

(52) U.S. Cl. 700/245; 901/1

(57) ABSTRACT

Disclosed herein a method of controlling the balance of a walking robot. In the method, a location and an acceleration of a center of gravity of the walking robot are detected in a three-dimensional (3D) x, y, z coordinate system. A location of a Zero Moment Point (ZMP) on an xy plane is detected using the location of the center of gravity and the acceleration of the center of gravity in x- and y-axis directions. Walking of the walking robot is controlled so that the ZMP is located inside a stable area including a bottom of a foot of the walking robot on the xy plane.

### CROSS-REFERENCE TO RELATED APPLICATIONS

The present application claims priority to Korean Patent Application No. 10-2012-0000026 filed on Jan. 2, 2012, the entire contents of which is incorporated herein for purposes by this reference.

### FIELD OF THE INVENTION

The present invention relates to a method of controlling the balance of a walking robot, which allows a wearable robot to balance itself and dynamically walk when the balance of the wearable robot is lost due to an external force.

### BACKGROUND OF THE INVENTION

Among technologies applied to the lower limbs of existing wearable muscular power assist robots, technology that allows a robot to balance itself has not yet been proposed. That is, research into existing robots has been aimed at improving the performance of a mechanism so that a wearable robot can exactly track actions taken by a wearing user in case of emergency, on the premise that the wearing user will recognize the emergency and take certain actions to balance himself or herself.

However, these technologies require significant time and expense to improve the performance of a mechanism and they do not exhibit satisfactory results.

Meanwhile, conventional technologies include the disclosure of a technology for calculating the Zero Moment Point (ZMP) of a robot and causing the ZMP to fall within a stable walking range based on the result of the calculation. However, according to the above conventional technology, complicated calculations must be performed using the motions of and the moment of inertia of each link of the robot in order to calculate the ZMP. Due thereto, it is difficult to guarantee the stability of the robot by rapidly measuring the ZMP.

Therefore, there is required a method of controlling the balance of a walking robot that can more easily predict the ZMP and use the prediction to maintain the walking stability of the robot, thus enabling the easy commercialization of the robot.

The foregoing is intended merely to aid in the better understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the prior art, and an object of the present invention is to provide a method of controlling the balance of a walking robot, which is easy to commercialize because a ZMP can be rapidly and easily calculated and the walking stability of the robot can be achieved based on the ZMP.

In order to accomplish the above object, the present invention provides a method of controlling balance of a walking robot, including a) detecting a location and an acceleration of a center of gravity of the walking robot in a three-dimensional (3D) x, y, z coordinate system; b) detecting a location of a Zero Moment Point (ZMP) on an xy plane using the location of the center of gravity and the acceleration of the center of gravity in x- and y-axis directions; and c) controlling walking of the walking robot so that the ZMP is located inside a stable area including a bottom of a foot of the walking robot on the xy plane.

Preferably, b) may be configured to obtain moments based on x- and y-axes by using gravity and the location and the acceleration of the center of gravity and detect a location of the ZMP on the xy plane by individually dividing the moments based on the x- and y-axes by a force of gravity.

Preferably, b) may be configured to detect the location of the ZMP on the xy plane using the following formulas:

$${X}_{zmp} \approx {x}_{CG} - {\ddot{x}}_{CG} \frac{{z}_{CG}}{g}$$

$${Y}_{zmp} \approx {y}_{CG} - {\ddot{y}}_{CG} \frac{{z}_{CG}}{g}$$

where x_{cg}, y_{cg}, and z_{cg} denote the location of the center of gravity, and \ddot{x}_{cg}, ÿ_{cg}, and \ddot{z}_{cg} denote the acceleration of the center of gravity.

Preferably, in c), the stable area may be an area over which the bottom of the foot of the walking robot makes contact with the ground surface, and be an entire area including areas of bottoms of two feet of the walking robot and an area connecting those areas when the bottoms of the two feet make contact with the ground surface.

Preferably, c) may include previously determining a subsequent step of the walking robot; previously predicting the ZMP based on the previously determined step; and if the predicted ZMP is not located inside a stable area based on the previously determined step, revising the subsequent step and changing the stable area so that the ZMP is located inside the stable area.

According to the method of controlling the balance of the walking robot having the above-described construction, the stability of a wearable muscular power assist robot can be maintained when an emergency occurs during the operation of the robot.

In detail, the present control method can be applied to various robots including two-legged robots once the basic mechanical characteristics of robots are known. Further, since existing two-legged walking robots perform balance control by controlling the joints of ankles and the location of the Center Of Mass (COM), they cannot cope with losing the balance. In contrast, in the present invention, even at the moment at which the balance of a robot is lost, a foot is located on the ground surface, thus guaranteeing the walking stability of the robot. Furthermore, even in an environment which is externally and arbitrarily changed, the stable walking of robot can be performed.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams showing a relationship between the balance control of a walking robot and a ZMP;

FIG. 3 is a flowchart showing a method of controlling the balance of a walking robot according to an embodiment of the present invention; and

FIG. 4 is a diagram showing walking based on the method of controlling the balance of a walking robot according to an embodiment of the present invention.

### DESCRIPTION OF THE PREFERRED EMBODIMENTS

Hereinafter, embodiments of a method of controlling the balance of a walking robot according to the present invention will be described in detail with reference to the attached drawings.

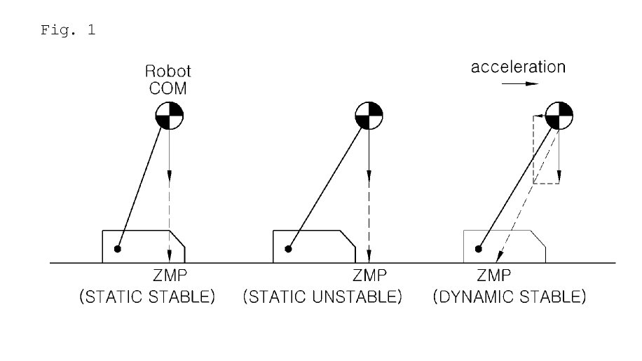

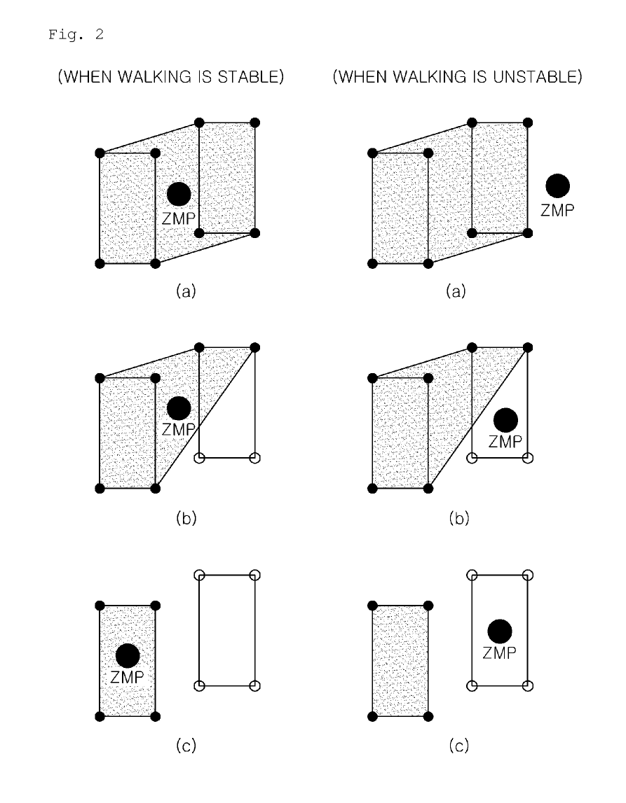

FIGS. 1 and 2 are diagrams showing a relationship between the balance control of a walking robot and a Zero Moment Point (ZMP). Referring to FIG. 1, a ZMP refers to a point at which a resultant force of inertia caused by the acceleration of the robot and gravity is projected on a ground surface. Further, the robot is determined to fall within a stable area when the ZMP is located inside a contact area over which the bottom of the foot of the robot makes contact with the ground surface.

Therefore, as shown in the drawing, the case where the ZMP is located inside the area of the bottom of the foot when the robot is stationary is represented by a “static stable state.” The case where the ZMP is located outside the area of the bottom of the foot when the robot is stationary is represented by a “static unstable state.” The case where the ZMP is located inside the area of the bottom of the foot when the robot is moving is represented by a “dynamic stable state.”

FIG. 2 is a diagram showing stable areas depending on the walking of the robot.

Case (a) shows that the stable area may be regarded as the entire area, including contact surfaces on which two feet of the robot make contact with the ground surface on which the robot stands on its two feet and an area which connects the two contact surfaces. When the ZMP is located inside the stable area, the current walking posture of the robot is a stable posture. When the ZMP deviates from the stable area, the current walking posture is in an unstable state in which the robot may fall down at any time.

Case (b) shows the case where only part of the bottom of the right foot makes contact with the ground surface (as reflected by the open nodes). This case means that the stable area is narrowed, and the probability of the ZMP deviating from the stable area increases.

Meanwhile, case (c) shows the state in which the robot is standing on only one foot. In this case, when the ZMP deviates from the stable area of the bottom of the left foot of the robot, the current posture is evaluated as an unstable posture.

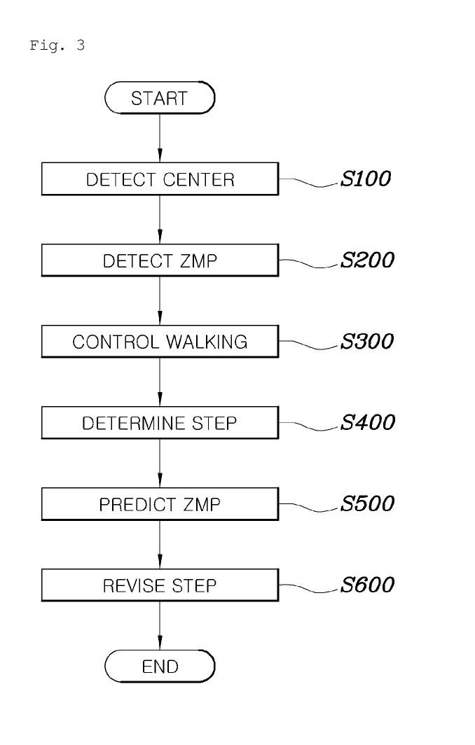

FIG. 3 is a flowchart showing a method of controlling the balance of a walking robot according to an embodiment of the present invention. The method of controlling the balance of the walking robot according to the present invention includes a center detection step S100, a ZMP detection step S200, and a walking control step S300. In step S100, the location and acceleration of the center of gravity of the walking robot are detected in a three-dimensional (3D) x, y, z coordinate system. In step S200, the location of a Zero Moment Point (ZMP) on an xy plane is detected using the location of the center of gravity and the acceleration of the center of gravity in the x- and y-axis directions. The walking of the walking robot is controlled so that the ZMP is located inside a stable area that includes the bottom of the foot of the walking robot on the xy plane.

That is, the present invention rapidly tracks the coordinates of the ZMP and performs control so that the ZMP is always located inside the stable area based on such tracking, thus enabling the walking of the robot to be stably and easily realized.

For this operation, the present invention performs the center detection step S100 of detecting the location and acceleration of the center of gravity of the walking robot in the 3D x, y, z coordinate system. With respect to the center of gravity, that is, the Center Of Mass (COM), of the robot, the coordinates of the current center of gravity of the robot are detected using kinematics, and the current acceleration of the center of gravity in the 3D x, y, z coordinate system is detected.

Further, the present invention performs the ZMP detection step S200 of detecting the location of the ZMP on the xy plane using the location of the center of gravity and the acceleration of the center of gravity in the x- and y-axis directions.

In this case, the ZMP detection step S200 may be configured to obtain moments based on the x- and y-axes by using gravity and the location and acceleration of the center of gravity, individually divide the x- and y-axis moments by the force of gravity, and then detect the location of the ZMP on the xy plane. In detail, the ZMP detection step S200 is configured to detect the location of the ZMP on the xy plane by using the following formulas:

$${X}_{zmp} \approx {x}_{CG} - {\ddot{x}}_{CG} \frac{{z}_{CG}}{g}$$

$${Y}_{zmp} \approx {y}_{CG} - {\ddot{y}}_{CG} \frac{{z}_{CG}}{g}$$

(1)
where x_{cg}, y_{cg}, z_{cg} in the location of the center of gravity and \ddot{x}_{cg}, ÿ_{cg}, and \ddot{z}_{cg} is the acceleration of the center of gravity.

For any origin, moments based on the center of gravity and x-, y- and z-axes around the origin may be represented by the following formulas:

Mₓ=mgx_{cg}−mÿ_{cg}z_{cg}

M_{y}=−mgx_{cg}+m\ddot{x}_{cg}z_{cg}

M_{z}=−m\ddot{x}_{cg}y_{cg}+mÿ_{cg}x_{cg} (2)

where Mₓ, M_{y}, M_{z} are moments of a reference coordinate system, x_{cg}, y_{cg}, z_{cg} is the location of the center of gravity, \ddot{x}_{cg}, ÿ_{cg}, \ddot{z}_{cg} is the acceleration of the center of gravity, m is the weight, and g is the acceleration of gravity.

In this case, the moments refer to moments on the x-, y-, and z-axes with respect to the center of gravity, and the ZMP does not require coordinates on the z axis. Accordingly, if it is assumed that a value related to the z-axis is ‘0’ in the formulas related to the moments, and the ZMP indicates coordinates at which the center of gravity is projected onto the ground surface (xy plane), z_{cg}=0, X_{zmp}=y_{cg} and Y_{zmp}=x_{cg} are satisfied as a result.

Therefore, the ZMP can be represented by the following formulas:

$${X}_{zmp} \approx - \frac{{M}_{y}}{m g} \\ {Y}_{zmp} \approx - \frac{{M}_{x}}{m g} \\ {X}_{zmp} \approx {x}_{CG} - {\ddot{x}}_{CG} \frac{{z}_{CG}}{g} \\ {Y}_{zmp} \approx {y}_{CG} - {\ddot{y}}_{CG} \frac{{z}_{CG}}{g} \qquad ( 3 )$$

As shown in the above formulas, if the location and acceleration of the center of gravity of the robot are detected, the ZMP can be very easily obtained. Therefore, the walking stability of the robot can be easily ensured when the walking of the robot is controlled with reference to the ZMP.

Meanwhile, the stable area of the walking control step S300 is an area over which the bottom of the foot of the walking robot makes contact with the ground surface, and may be an entire area including areas of the bottoms of the two feet and an area connecting those areas when the bottoms of the two feet make contact with the ground surface.

Further, the walking control step S300 may include the step determination step S400 of previously determining a subsequent step of the walking robot, the ZMP prediction step S500 of previously predicting a ZMP based on the previously determined step, and the step revision step S600 of, if the predicted ZMP is not located inside a stable area based on the previously determined step, revising the subsequent step and changing the stable area so that the ZMP is located inside the stable area.

That is, the method of controlling the balance of the walking robot according to the present invention controls the walking of the robot by detecting the center of gravity and the ZMP. However, when the robot previously determines its subsequent step, the movement of the ZMP and the stable area based on the subsequent step are also calculated, and then it is determined whether the ZMP is located inside the stable area. If it is determined that the ZMP is not located inside the stable area, the stable area must be changed so that the ZMP is located inside the stable area, and then the walking of the robot must be corrected.

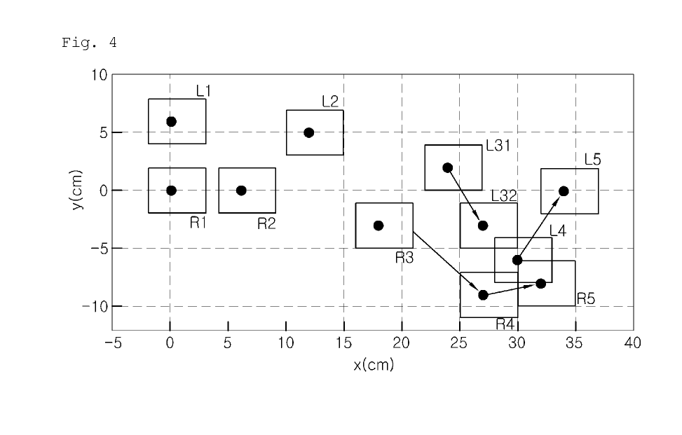

FIG. 4 is a diagram showing walking based on the method of controlling the balance of the walking robot according to an embodiment of the present invention. As shown in the drawing, if the robot walks along coordinates (R1, L1), (R2, L2), and (R3, L31) and then walks while moving from the coordinates L31 to L32 due to the state of a slanted ground surface, the right foot of the robot moves from R3 to R4 and the left foot of the robot moves from L32 to L4 in response to the deviation of the ZMP. Accordingly, the ZMP changes again and goes outside the stable area, so that the robot is stabilized while moving from L4 to L5.

According to the method of controlling the balance of the walking robot having the above-described construction, the stability of a wearable muscular power assist robot can be maintained when an emergency occurs during the operation of the robot.

In detail, the present control method can be applied to various robots including two-legged robots once the basic mechanical characteristics of robots are known. Further, since existing two-legged walking robots perform balance control by controlling the joints of ankles and the location of the Center Of Mass (COM), they cannot cope with losing the balance. In contrast, in the present invention, even at the moment at which the balance of a robot is lost, a foot is located on the ground surface, thus guaranteeing the walking stability of the robot. Furthermore, even in an environment which is externally and arbitrarily changed, the stable walking of robot can be performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Furthermore, the control logic of the present invention can be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

What is claimed is:

1. A method of controlling balance of a walking robot, comprising:
a) detecting a location and an acceleration of a center of gravity of the walking robot in a three-dimensional (3D) x, y, z coordinate system;
b) detecting a location of a Zero Moment Point (ZMP) on an xy plane using the location of the center of gravity and the acceleration of the center of gravity in x- and y-axis directions; and
c) controlling walking of the walking robot so that the ZMP is located inside a stable area including a bottom of a foot of the walking robot on the xy plane.

2. The method according to claim 1, wherein b) is configured to obtain moments based on x- and y-axes by using gravity and the location and the acceleration of the center of gravity and detect a location of the ZMP on the xy plane by individually dividing the moments based on the x- and y-axes by a force of gravity.

3. The method according to claim 1, wherein b) is configured to detect the location of the ZMP on the xy plane using the following formulas:
$${X}_{zmp} \approx {x}_{CG} - {\ddot{x}}_{CG} \frac{{z}_{CG}}{g}$$
$${Y}_{zmp} \approx {y}_{CG} - {\ddot{y}}_{CG} \frac{{z}_{CG}}{g}$$
where x_{cg}, y_{cg}, and z_{cg} denote the location of the center of gravity, and \ddot{x}_{cg}, ÿ_{cg}, and \ddot{z}_{cg} denote the acceleration of the center of gravity.

4. The method according to claim 1, wherein in c), the stable area is an area over which the bottom of the foot of the walking robot makes contact with the ground surface, and is an entire area including areas of bottoms of two feet of the walking robot and an area connecting those areas when the bottoms of the two feet make contact with the ground surface.

5. The method according to claim 1, wherein c) comprises:
previously determining a subsequent step of the walking robot;
previously predicting the ZMP based on the previously determined step; and
if the predicted ZMP is not located inside a stable area based on the previously determined step, revising the subsequent step and changing the stable area so that the ZMP is located inside the stable area.

6. A non-transitory computer readable medium containing program instructions executed by a processor or controller, the computer readable medium comprising:
a) program instructions that detect a location and an acceleration of a center of gravity of the walking robot in a three-dimensional (3D) x, y, z coordinate system;
b) program instructions that detect a location of a Zero Moment Point (ZMP) on an xy plane using the location of the center of gravity and the acceleration of the center of gravity in x- and y-axis directions; and
c) program instructions that control walking of the walking robot so that the ZMP is located inside a stable area including a bottom of a foot of the walking robot on the xy plane.
